(19) United States
(12) Patent Application Publication
(10) Pub. No.: US 2013/0121620 A1
(43) Pub. Date: May 16, 2013

(54) EXTENDED FUNCTION PROCESSING APPARATUS, AND EXTENDED FUNCTION PROCESSING METHOD

(71) Applicant: Ryoichi Suzuki, Kawasaki (JP)

(72) Inventor: Ryoichi Suzuki, Kawasaki (JP)

(21) Appl. No.: 13/675,508

(22) Filed: Nov. 13, 2012

(30) Foreign Application Priority Data
Nov. 11, 2011 (JP) 2011-247885

(51) Int. Cl. G06T 1/00

(52) U.S. Cl. CPC G06T 1/00
USPC 382/307

(57) ABSTRACT

An extended function processing apparatus connectable to a plurality of image processing apparatuses. The extended function processing apparatus includes a network interface configured to connect to the plurality of image processing apparatuses, and a receiving unit configured to receive a request for executing an extended function from at least one of the plurality of image processing apparatuses. There are a plurality of execution units configured to respectively execute extended functions in response to the request received by the receiving unit. Further, there is a control unit configured to, when the receiving unit receives the request from one of the plurality of image processing apparatuses, execute the extended function requested using one of the plurality of execution units.

### CROSS-REFERENCE TO RELATED APPLICATIONS

The present application claims priority under 35 U.S.C. §119(a) to and incorporates by reference the entire contents of Japanese Patent Application No. 2011-247885 filed in Japan on Nov. 11, 2011.

### BACKGROUND

Japanese Patent Application Laid-open No. 2007-035049 describes an image processing apparatus which includes a normal controller and an extended controller.

In this image processing apparatus, the normal controller executes normal functions and the extended controller executes extended functions.

### SUMMARY

Aspects of this disclosure relate to extended function processing apparatuses, device, processes, algorithms and systems.

An extended function processing apparatus can include a network interface configured to connect to a plurality of image processing apparatuses, a receiving unit configured to receive a request for executing an extended function from at least one of the plurality of image processing apparatuses, a plurality of execution units configured to respectively execute extended functions in response to the request received by the receiving unit, and a control unit configured to, when the receiving unit receives the request from one of the plurality of image processing apparatuses, execute the extended function requested using one of the plurality of execution units.

An extended function executing method on an extended function processing apparatus can include connecting, to a plurality of image processing apparatuses via a network interface included in the extended function processing apparatus, receiving, a request for executing an extended function among extended functions from at least one of the plurality of image processing apparatuses and executing, in response to the request, the extended function requested by the request among the extended functions.

According to another aspect of the invention, there is a processing apparatus which includes a network interface configured to connect to a plurality of image processing apparatuses, and a receiver for receiving a request for executing an extended function from at least one of the plurality of image processing apparatuses. There is a plurality of execution units configured to respectively execute extended functions in response to the request received by the receiving unit, and a memory including a data structure for storing information of extended functions available for execution, the data structure including a table which stores an identification of a function, an input device to be used by the function, a process related to the function, and an output used by the function. Further, there is a device configured to add an additional entry in the data structure for storing information so that another extended function is added to the processing apparatus, and a control unit configured to, when the receiving unit receives the request from one of the plurality of image processing apparatuses, execute the extended function requested using one of the plurality of execution units.

The foregoing paragraphs have been provided by way of general introduction, and are not intended to limit the scope of the claims. The described exemplary implementations, together with further advantages, will be best understood by reference to the following detailed description taken in conjunction with the accompanying drawings, wherein like reference numerals designate identical or corresponding parts throughout the several views.

### BRIEF DESCRIPTION OF THE DRAWINGS

FIG. 1 is a block diagram of a system configuration of an extended function processing system;

FIGS. 2A and 2B are tables indicating an input, a process and an output;

FIG. 3 is a block diagram of an extended function processing apparatus;

FIG. 4 is a diagram illustrating a functional configuration of the extended function processing apparatus;

FIG. 5A is a table indicating a function;

FIG. 5B is a table indicating a validity of functions;

FIG. 6 is a screen image of function menu.

FIG. 7A is a sequence diagram illustrating a procedure for a process of registering an extended function;

FIG. 7B is a sequence diagram illustrating a procedure for a process of executing an extended function;

FIG. 7C is a sequence diagram illustrating a procedure for a process of adding an extended function; and

FIG. 8 is a flowchart illustrating a procedure for updating a valid function.

### DETAILED DESCRIPTION

Hereinafter, exemplary implementations will be described with reference to the accompanying drawings. However, variations and modifications may be made without departing from the basic concepts described herein.

In an extended function processing system, an extended function processing apparatus is used to execute an extended function. In a conventional image processing apparatus, a normal controller executes a normal function and the extended controller executes an extended function. Thus, the conventional image forming apparatus can not execute the extended function without the extended controller.

However, when a plurality of image processing apparatuses are in an office and the plurality of image processing apparatuses need an extended function, an installation of the extended controller takes a lot of time and is expensive.

In an extended function processing system according to aspects of this disclosure, the extended function processing system is able to provide, to a plurality of image processing apparatuses, an extended function shared by the plurality of image processing apparatuses.

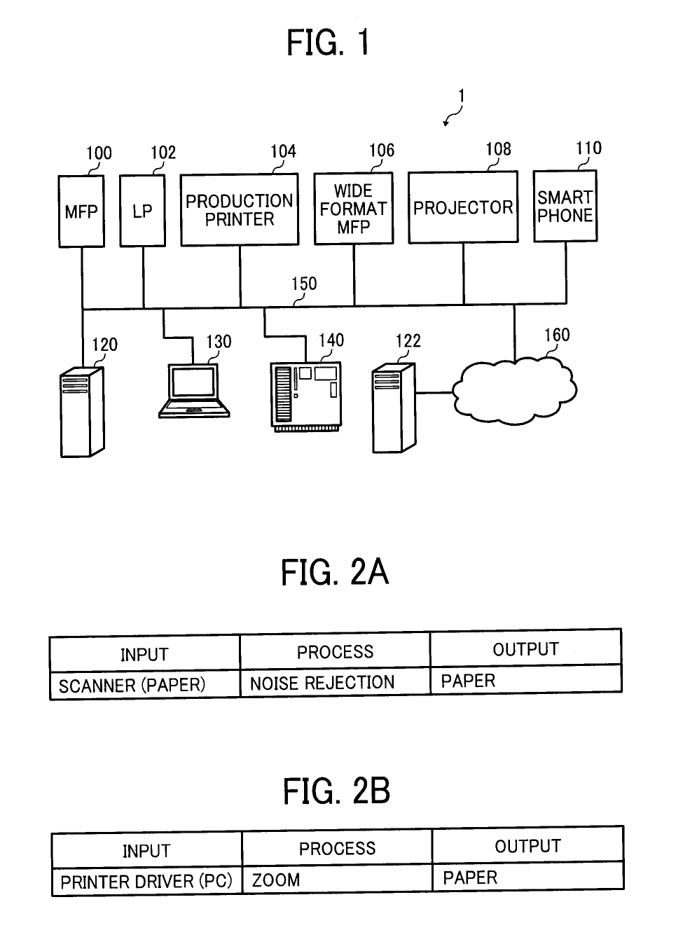

FIG. 1 is a block diagram of a system configuration of the extended function processing system 1.

As illustrated in FIG. 1, the extended function processing system 1 includes a plurality of image processing apparatuses which executes an image processing. Further, the plurality of image processing apparatuses includes a multifunction peripheral (MFP) 100, a laser printer (LP) 102, a production printer 104, a wide format MFP 106, a projector 108 and a smart phone 110, for example.

The extended function processing system 1 further includes a first extended function processing apparatus 120, a personal computer 130 and a server 140, which are connected via a network 150. The extended function processing system 1 further includes a second extended function processing apparatus 122 which is connected to the network 150 via an external network 160.

The MFP 100 has a copy function, facsimile function, a printer function and a scanner function. Further, the MFP 100 processes image data input by scanning a page or receiving electronic image data, and outputs the processed image data on a recording medium or as data.

The LP 102 outputs input image data on a recording medium using laser printing technology. The production printer 104 is a high speed, high volume printer and may be implemented using a laser printer, impact printer, an LED printer, or other desired technology. The wide format MFP 106 prints input image data on a wide format paper. A wide format is considered, for example, to be a format at least 13 inches in width. Alternatively, the wide format printer prints at least 24 inches in width.

The projector 108 projects input image data on a screen. The smart phone 110 is a cellular phone having computing capabilities and utilizes an operating system such as Android, IOS, or Windows, for example. Further, the smart phone 110 is able to send or receive image data via the network 150, and obtain image data using a camera of the smart phone 110.

The extended function processing apparatus 120 extends an image processing function of the plurality of image processing apparatuses. Due to the extended function processing apparatus 120, the plurality of image processing apparatuses is able to execute one or more functions which they are not able to execute by themselves.

For example, the extended function processing apparatus 120 provides, as an exemplary extended function, an optical character reader (OCR) function to the plurality of image processing apparatuses. In this case, an image processing apparatus which has an image input device for inputting image data from the plurality of image processing apparatuses is able to execute an OCR process on the input image data using the extended function processing apparatus 120, and is able to send, to the server 140, text data obtained from the extended function processing apparatus as a result of the OCR process.

Another example, the extended function processing apparatus 120 provides, as an extended function, a printing function to the plurality of image processing apparatuses. In this case, an image processing apparatus including a printing device for printing image data among the plurality of image processing apparatuses is able to execute a printing process to print image data stored in the server 140.

Another example, the extended function processing apparatus 120 provides, as an extended function, a projection function to the plurality of image processing apparatuses. In this case, the projector 106 is able to project image data input from one of the plurality of image processing apparatuses.

The extended processing apparatus 122 is the same as the extended processing apparatus 120, according to an embodiment of the invention. Further, the extended processing apparatus 122 is connected to the network 150 via an external network 160. The external network 160, for example, includes the Internet. The network 150, for example, includes an intranet network, a local area network (LAN) and/or a wireless network, for example.

The personal computer 130 is a device for adding an extended function to the extended function processing apparatuses 120 and 122, for example.

The server 140 includes a function for storing files. Further, the server 140 stores a file input from the extended processing apparatuses 120 and 122, and outputs the stored file to the extended processing apparatuses 120 and 122.

Furthermore, the plurality of image processing apparatuses additionally includes a digital camera, a digital signage and a TV conference system, for example.

In the extended function processing system, an extended function provided by the extended function processing apparatus is provided by combining with an image input process for inputting image data, an image processing process for processing the image data and an image output process for outputting the image data.

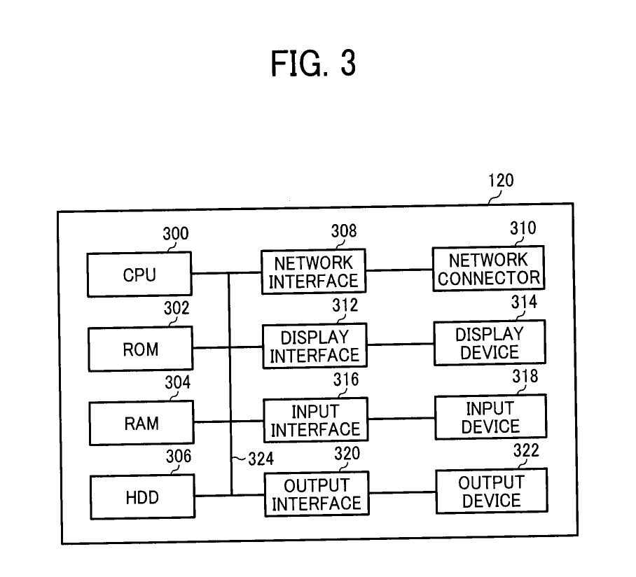

FIGS. 2A and 2B are tables indicating the image input process, the image processing process and the image output process. The MFP 100 executes an image processing on an image input by paper, a Fax, a printer driver, or another input mechanism or source.

For example, as illustrated in FIG. 2A, the MFP 100 executes an input process for inputting an image of a document using a scanner, executes image processing for noise reduction of the scanned image, and executes an output process for outputting the processed image on a paper. This noise reduction or noise rejection process is an extension or enhancement to the copy function.

As another example, as illustrated in FIG. 2B, a zoom printing function executed by the MFP 100 is defined. In the zoom printing function, the MFP 100 executes an input process for inputting image by a printer driver from the PC 130, executes an image processing process for zooming the input image, and executes an output process for outputting the processed image on a paper.

Further, in the extended function processing system, a new function is able to be added on the extended function system by defining the combination of an input process, an image processing process and an output process. By using the defined combination, the extended function processing system is able to provide the plurality of image processing apparatuses with an extended function which is able to be shared among the plurality of image processing apparatuses.

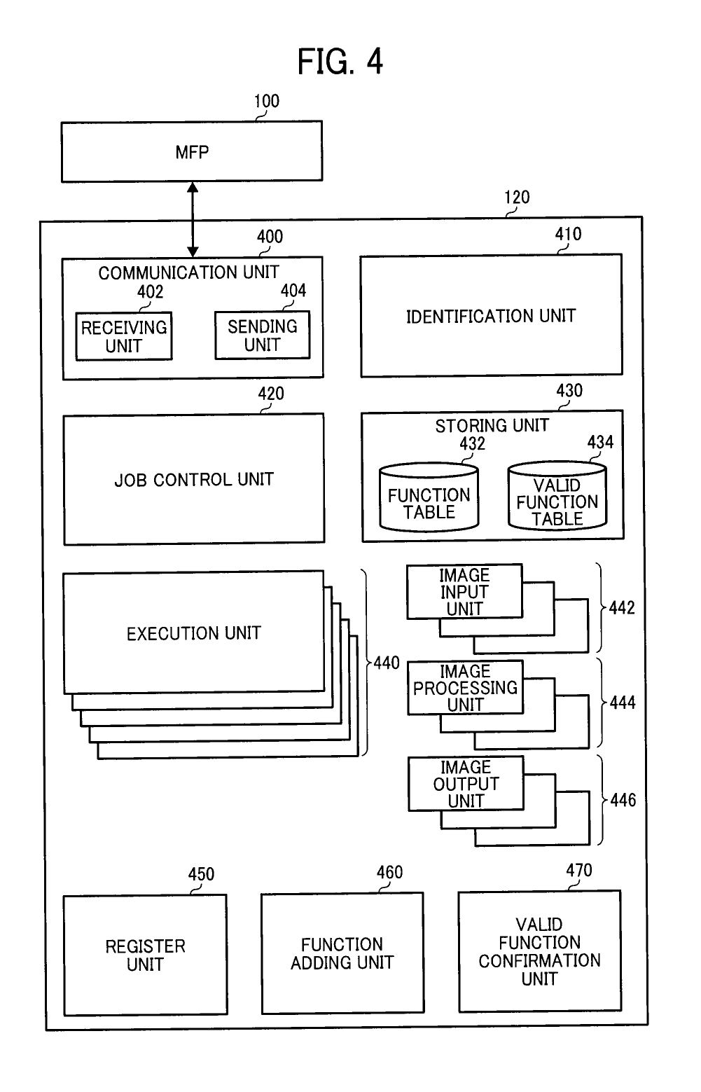

FIG. 3 is a block diagram of the hardware of the extended function processing apparatus 120.

As illustrated in FIG. 3, the extended function processing apparatus 120 includes a central processing unit

(CPU) 300, a read only memory (ROM) 302, a random access memory (RAM) 304, a hard disk drive (HDD) 306, a network interface 308, a display interface 312, an input interface 316, and an output interface 320 which are mutually connected to each other by a bus 324. Further, the extended function processing apparatus 120 further includes a network connector 310, a display device 314, an input device 318 and an output device 322.

The CPU 300 reads out an extended function processing program from the ROM 302 and executes the read extended function processing program by using the RAM 304 as a working memory. The HDD 306 stores programs and data, which are used by the extended function processing apparatus 120.

The network interface 308 executes a connecting process to connect to an external apparatus via the network connector 310. The display interface 312 displays a display image on the display device 314. The input interface 316 receives input from the input device 318. For example, the input device 318 includes a keyboard and mouse. The output interface 320 outputs data to the output device 322.

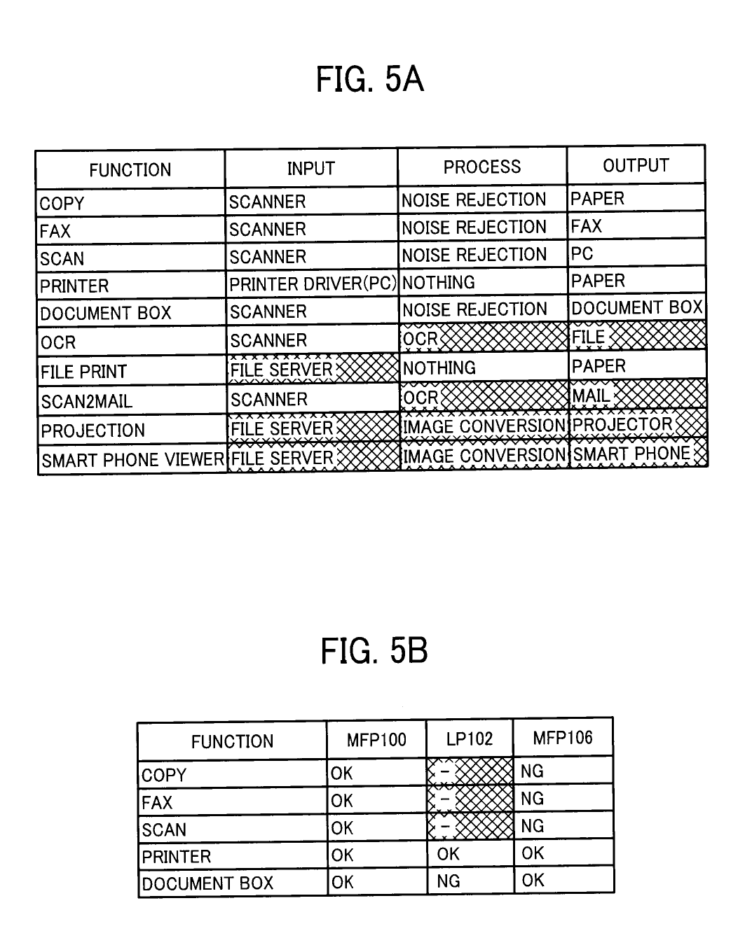

FIG. 4 is a diagram illustrating a functional configuration of the extended function processing apparatus 120.

As illustrated in FIG. 4, the extended function processing apparatus 120 includes a communication unit 400, an identification unit 410, a job control unit 420, a storing unit 430, a plurality of execution units 440, a plurality of image input units 442, a plurality of image processing units 444, a plurality of image output units 446, a register unit 450, a function adding unit 460 and a valid function confirmation unit 470.

The communication unit 400 communicates with an external apparatus connected via the network 150 or the external network 160. Further, the communication unit 400 communicates with the external apparatus by using a protocol, for example, Transmission Control Protocol/Internet Protocol (TCP/IP), File Transfer Protocol (FTP), Server Message Block (SMB), Hypertext Transfer Protocol (HTTP), Hypertext Transfer Protocol over Secure Socket Layer (HTTPS) and Web-based Distributed Authoring and Versioning (WebDAV).

Further, the communication unit 400 includes a receiving unit 402 and a sending unit 404. The receiving unit 402 receives a request for executing an extended function from each of the plurality of image processing apparatuses. Depending on the extended function, the receiving unit 402 further receives image data from each of the plurality of image processing apparatuses.

The sending unit 404 sends, to a destination, an instruction for outputting or an output data.

The identification unit 410 identifies a model of the device communicated by the communication unit 400. The identification unit 410 further identifies a kind of software installed in the device communicated by the communication unit 400. By identifying the model of the device and the kind of software installed in the device, the identification unit 410 is able to determine a protocol and software which are to be executed for an extended function.

The job control unit 420 controls a request for executing an extended function received by the receiving unit 420 as a job. Further, the job control unit 420 controls an execution for the job. Further, when a plurality of the request are received by the receiving unit 420, the job control unit 420 executes a plurality of jobs based on the plurality of requests by queuing the plurality of jobs.

The storing unit 430 stores a function table 432 and a valid function table 434. The function table 432 defines a function which is used by the plurality of image processing apparatuses. The function table 432 defines an input process, an image processing process and an output process for every function. Further, each of the plurality of image processing apparatuses is able to refer to the function table 432.

The valid function table 434 defines a state of a function which is able to be executed on each the plurality of image processing apparatuses among functions defined by the function table 432. The valid function table 434 is updated when one of the plurality of image processing apparatuses gets to a status which is not able to execute the function. For example, the status includes a status of failure and a status of being out of a consumable supply.

The execution unit 440 executes processes of an input process, an image processing process and an output process when the receiving unit 402 receives a request for executing an extended function. Further, there are one or more execution units 440 corresponding to extended function(s).

The image input unit 442 executes an input process for executing an extended function. In detail, the image input unit 442 is an input module which reads image data based on the input defined by the function table 432.

Further, there are one or more image input units 442 corresponding to input hardware or software. When a new input hardware or software is added, the image processing apparatus 120 is able to read image data from the new input hardware or software by adding the image input unit 442 corresponding to the new input hardware or software. Further, the image input unit 442 sends the read image data to the image processing unit 444.

The image processing unit 444 executes an image processing process for executing an extended function. In detail, the image processing unit 444 is an image processing module which processes the image data sent from the image input unit 442 based on the process defined by the function table 432.

Further, the image processing apparatus 120 has one or more image processing units 444 corresponding to a type of image processing. Further, the image processing apparatus 120 is able to add a new image process by adding another image processing unit 444 corresponding to the new image process. Further, the image processing unit 444 sends the processed image data to the image output unit 446. The image processing includes, for example, a noise rejection, an optical character reader (OCR), an image conversion, a skip white paper function, a reduced colors function, and color conversion.

Further, there is a case that the image processing apparatus 120 outputs the input image data without any image processing. In this case, the image processing unit 444 sends the image data received from the input unit 442 to the image output unit 446 without any image processing. Further, the image processing apparatus 120 is able to control the input unit 442 to send the input image data to the image output unit 446 directly.

The image output unit 446 executes an image output process for executing an extended function. In detail, the image output unit 446 is an image output module which outputs the image data processed by the image processing unit 444 based on the process defined by the function table 432.

Further, there are one or more image output units 446 corresponding to output hardware or software. When a new output hardware or software is added, the image processing apparatus 120 is able to output image data to the new output hardware or software by adding the image output unit 446 corresponding to the new output hardware or software.

The register unit 450 registers an apparatus which uses an extended function. By registering, the extended function processing apparatus 120 is able to provide the extended function to the plurality of image processing apparatuses.

The function adding unit 460 adds an extended function to the extended function processing apparatus 120 based on an operation by a user. In detail, when the extended function processing apparatus 120 receives the image input unit 442, the image processing unit or the image output unit which are to be added, the extended function processing apparatus 120 defines a new execution unit 440 and updates the function table 432.

The valid function confirmation unit 470 confirms whether a function of the plurality of image processing apparatuses is valid or not. Further, the valid function confirmation unit 470 sends, to the plurality of image processing apparatuses by using a protocol, a request for confirming whether the function of the plurality of image processing apparatuses is valid or not. When a portion of the function is not valid, the extended function processing apparatus 120 stores, in the valid function table 434, a content that the portion of the function is not valid.

In accordance with the above, the extended function processing apparatus 120 is able to provide, to the plurality of image processing apparatuses, an extended function realized by a combination of an input, a process and an output.

The function table 432 and the valid function table 434 will be described below.

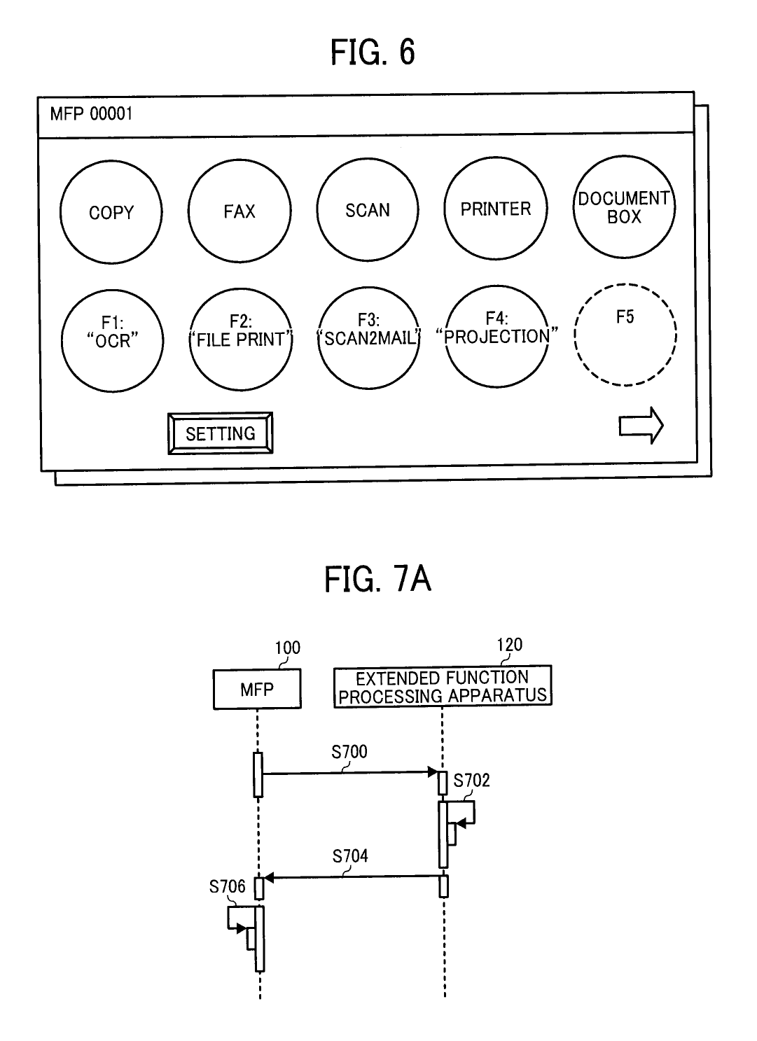

FIG. 5A is a table indicating a function.

As illustrated in FIG. 5A, the table indicating the function has items which include an item of a function, an item of an input, an item of a process and an item of an output.

The item of the function indicates the name of the function. Herein, the function includes a standard function and an extended function. The standard function includes, for example, Copy and Fax. Further, the extended function includes, for example, OCR and FilePrint.

The item of the input indicates an input resource for input data. For example, in case that the input resource is a scanner, the input data is the data scanned by scanner. For another example, in case that the input resource is a file server, the input data is the data stored in the server 140. Herein, the shaded region of the table in the input column indicates that data is input by another apparatus.

The item of the process indicates a type of processing on the data. For example, when the content of processing is noise rejection, the process for noise rejection on the input data is executed. For another example, in case that the content of processing is OCR, the process for OCR on the input data is executed. Herein, the shaded region of the table in the process column indicates that process is executed by another apparatus.

The item of the output indicates an output resource for processed data. For example, when the output resource is a paper, the processed data is output on paper by a printer. For another example, when the output resource is projector, the processed data is projected on screen by the projector 108. Herein, the shaded region of the table in the output column indicates that data is output by other apparatus.

In OCR which is one of the extended functions, image data input by a scanner or other source is processed for OCR and the processed image data is output as a file. Further, in Smart Phone Viewer which is one of the extended functions, image data input from a file server is processed for image conversion and the processed data is displayed on the smart phone 110.

Further, the extended function processing apparatus is able to add a new extended function by defining the new extended function on the function table.

FIG. 5B is a table indicating a valid function.

As illustrated in FIG. 5B, the illustrated table indicates whether the function defined by the function table 5A is valid. The table includes an item of a function and one or more items of the plurality of image processing apparatuses. In this embodiment, the one or more items include MFP 100, LP 102 and MFP 106.

The item of a function corresponds to the function defined by the function table 5A. The table indicates whether each image processing apparatus is able to execute the function. “OK” indicates that an image processing apparatus is able to execute the function. “-” indicates that the image processing apparatus is not able to execute the function from the beginning. “NG” indicates that the image processing apparatus is not able to execute the function temporarily due to trouble of the image processing apparatus or the image processing apparatus being out of a consumable supply. Thus, the extended function processing apparatus is able to recognize a valid function using the table indicating a valid function of FIG. 5B.

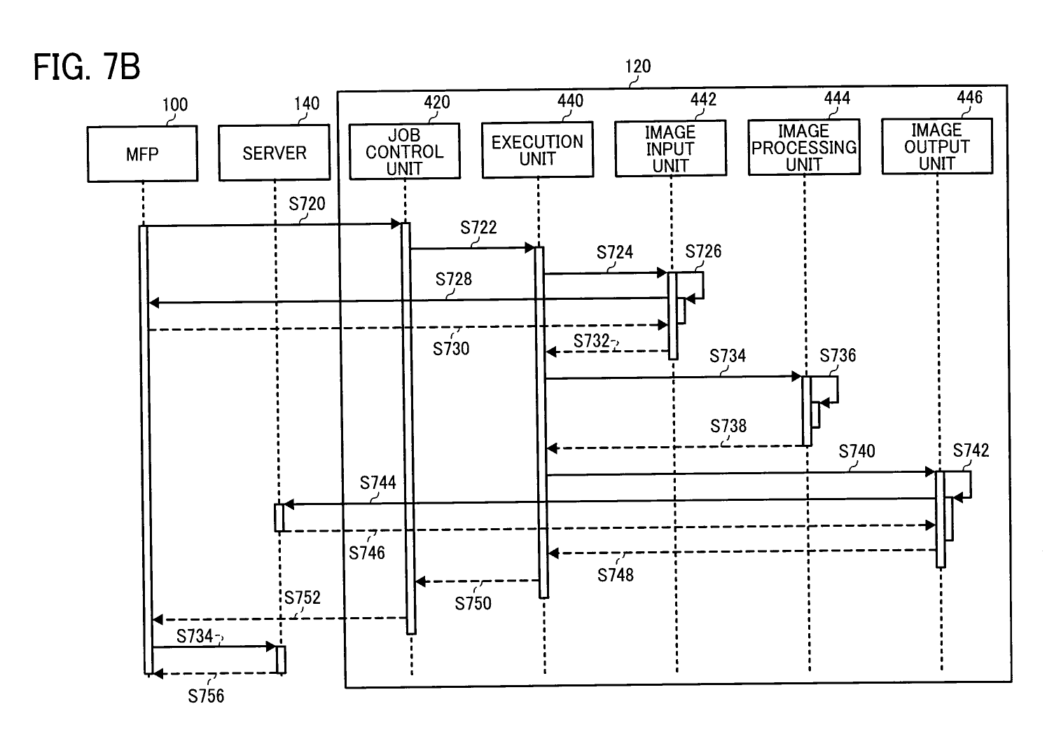

FIG. 6 is a screen image of a function menu on the MFP 100. The screen image of the function menu is displayed based on the function table 432 and the valid function table 434. The MFP 100 executes each function by user selection on the MFP 100.

As illustrated in FIG. 6, normal functions are displayed on upper part of a screen of the MFP 100. The normal functions include a copy function, a FAX function, a scan function, printer function and a document box function. On the other hand, extended functions are displayed on bottom part of a screen of the MFP 100. The extended functions include an OCR function, a file print function, scan to email function and a projection function.

Further, F5 which circled with a dotted line indicates that no extended function is registered. Further, the extended functions to be displayed are decided by a user of the MFP 100. Thus, each of the plurality of image processing apparatuses is able to display valid functions based on the function table 432 and the valid function table 434.

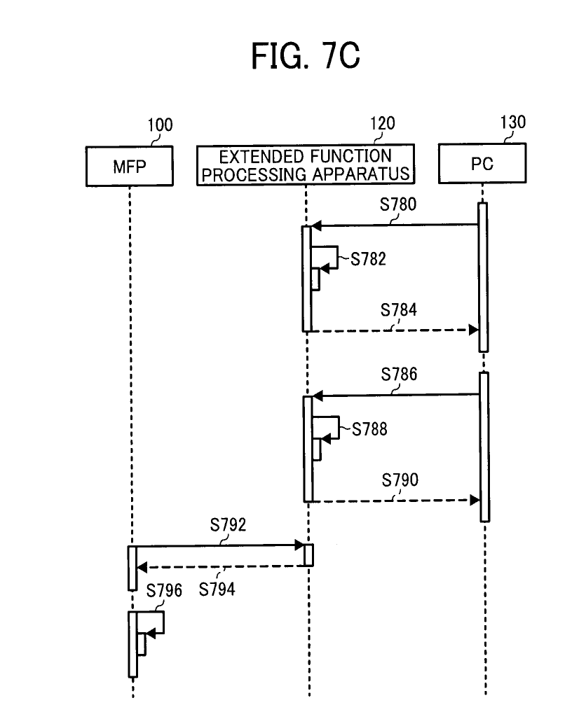

FIG. 7A is a sequence diagram illustrating a procedure for a process of registering an extended function.

As illustrated in FIG. 7A, the extended function processing apparatus 120 receives a packet for finding the extended function processing apparatus 120 sent from the MFP 100 (step S700). For example, the packet is sent by broadcasting or multicasting. Next, in response to receiving the packet, the extended function processing apparatus 120 registers the MFP 100 (step S702). In detail, an entry of the MFP 100 is added to the valid function table 434.

Next, the extended function processing apparatus 120 sends to the MFP 100, a packet indicating the MFP 100 is registered with the extended function processing apparatus 120 (step S704). Next, the MFP 100 registers the extended function processing apparatus 120 (step S706). By this registration, the MFP 100 is able to use an extended function provided by the extended function processing apparatus 120.

FIG. 7B is a sequence diagram illustrating a procedure for a process of executing an extended function. In this embodiment, the extended function is an OCR function.

As illustrated in FIG. 7B, the job control unit 420 receives a request for executing the OCR function sent from the MFP 100 via the receiving unit 402 (step S720). The request includes setting information which is needed to execute the OCR function. For example, the setting information includes the type of language and an output file name. Further, the job control unit controls the request as a job.

Next, in response to receiving a request for executing a job sent from the job control unit 420, the execution unit 440 executes the OCR function based on the request for executing job (step S722). Next, the execution unit 440 sends an instruction for inputting image data to the image input unit 442 (step S724). In response to receiving the instruction sent from the execution unit 440, the image input unit 442 executes an image input process for inputting image data (step S726). In this input process, the image input unit 442 sends to the MFP 100 a request for reading image data by scanning (step S728). Further, the image input unit 442 receives image data scanned by the MFP 100 sent from the MFP 100 (step S730).

Next, in response to receiving the image data sent from the MFP 100, the image input unit 442 sends a message indicating the input process is completed to the execution unit 440 (step S732). The execution unit 440 then sends, to the image processing unit 444, an instruction for processing the image data input by the image input unit 442 (step S734).

Next, the image processing unit 444 executes an image processing process for processing the image data input by the image input unit 442 (step S736). In detail, the image processing unit 444 executes the OCR process based on the kind of language, and generates text data.

The image processing unit 444 then sends a message indicating the image processing process is completed to the execution unit 440 (step S738). Next, the execution unit 440 sends, to the image output unit 446, an instruction for outputting the image data processed by the image processing unit 444 (step S740).

The image output unit 446 executes an output process for outputting the result of image processing processed by the image processing unit 444 (step S742). In this process, the image output unit 446 outputs the result of the image processing to the server 140 (step S744). Further, the image output unit 446 receives, from the server 140, a message indicating the result of the image processing is stored in the server 140 (step S746).

Next, the image output unit 446 sends a message indicating the output process is completed to the execution unit 440 (step S748). The execution unit 440 then sends, to the job control unit 420, a message indicating that a process for executing the OCR function is completed (step S750).

Next, the job control unit 420 sends, to the MFP 100, a message indicating that the process for executing the OCR function is completed (step S752). The MFP 100 then sends a request for obtaining the result of the image processing to the server 140 (step S734). The server 140 then sends the result of image processing to the MFP 100 (step S756).

FIG. 7C is a sequence diagram illustrating a procedure for a process of adding an extended function.

As illustrated in FIG. 7C, the PC 130 sends to the extended function processing apparatus 120, a module for executing an extended function (step S780). In this embodiment, the module includes the image input unit 442, the image processing unit 444 and the image output unit 446.

Next, the function adding unit 460 of the extended function processing apparatus 120 determines whether the module sent from the PC 130 is able to be used by the extended function processing apparatus 120 (step S782). Further, when the function adding unit 460 determines that the module sent from the PC 130 is able to be used by the extended function processing apparatus 120, the function adding unit 460 stores the module sent from the PC 130.

The function adding unit 460 then sends to the PC 130, a message indicating that storing of the module sent from the PC 130 is completed (step S784). Next, the PC 130 sends a definition for a new extended function to the extended function processing apparatus 120 (step S786). The definition for the new extended function is defined by combination with the image input unit 442, the image processing unit 444 and the image output unit 446. Next, the function adding unit 460 updates the function table 432 based on the definition sent from the PC 130 (step S788). The function adding unit 460 then sends to the PC 130, a message indicating that adding the new extended function is completed (step S790). The MFP 100 connects to the extended function processing apparatus 120 (step S792).

Next, the function adding unit 460 sends the updated function table 432 to the MFP 100 (step S794). The MFP 100 then updates the screen image of function menu based on the updated function table 432 sent from the function adding unit 460 (step S796).

Thus, each the plurality of image processing apparatuses is able to use the new extended function without installing the function on each of the plurality of image processing apparatuses.

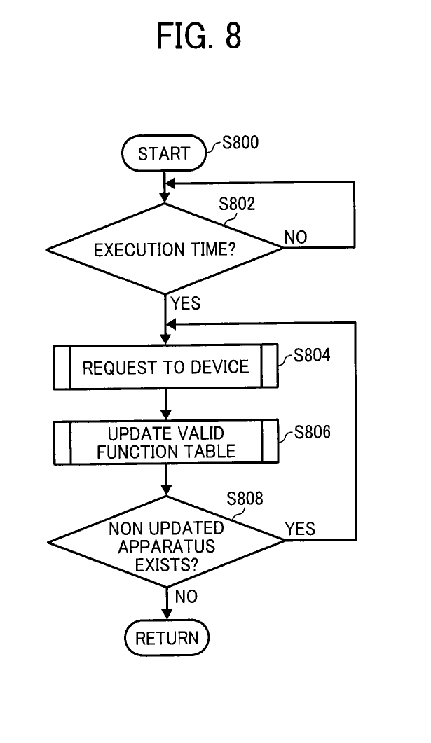

FIG. 8 is a flowchart illustrating a procedure forupdating a valid function.

As illustrated in FIG. 8, the extended function processing apparatus 120 starts an update process. Next, the valid function confirmation unit 470 determines whether now is an execution time to update the valid function table 434 (step S802). When it is not the execution time (step S802: NO), flow returns back to the start of step S802.

When now is the execution time (step S802: YES), the valid function confirmation unit 470 sends to the plurality of image processing apparatuses, a request asking whether the extended function defined by the function table 432 is able to be executed (step S804).

Next, in response to receiving a response to the request from an image processing apparatus, the valid function confirmation unit 470 updates the valid function table 434 based on the response(s) sent from the image processing apparatuses (step S806).

The valid function confirmation unit 470 then determines whether any non-updated apparatuses exist among the plurality of image processing apparatuses (step S808). When a non-updated apparatus exists (step S808: YES), flow returns to step S804 and the valid function confirmation unit 470 executes again the process S804. When there are no non-updated apparatuses (step S808: NO), the process ends.

The descriptions provided herein are only exemplary, and variations and modifications may be made without departing from the concepts discussed herein.

What is claimed is:

1. A processing apparatus, comprising:
a network interface configured to connect to a plurality of image processing apparatuses;
a receiving unit configured to receive a request for executing an extended function from at least one of the plurality of image processing apparatuses;
a plurality of execution units configured to respectively execute extended functions in response to the request received by the receiving unit; and
a control unit configured to, when the receiving unit receives the request from one of the plurality of image processing apparatuses, execute the extended function requested using one of the plurality of execution units.

2. The processing apparatus as claimed in claim 1, further comprising:
an image input unit configured to input image data;
an image processing unit configured to process the image data input by the image input unit; and
an image output unit configured to output the image data processed by the image processing unit; and
wherein the plurality of execution units respectively execute the extended functions using the image input unit, the image processing unit and the image output unit.

3. The processing apparatus as claimed in claim 1, further comprising:
an extended function adding unit configured to add a extended function in the extended functions.

4. The processing apparatus as claimed in claim 1, further comprising:
a function table storing unit configured to store a function table that indicates the extended functions.

5. The processing apparatus as claimed in claim 4, further comprising:
a valid function table storing unit configured to store a valid function table that indicates an extended function which is able to be executed on each the plurality of image processing apparatuses among the extended functions defined by the function table.

6. An extended function executing method on an extended function processing apparatus, comprising:
connecting to the plurality of image processing apparatuses via a network interface included in the extended function processing apparatus;
receiving a request for executing an extended function among extended functions from at least one of the plurality of image processing apparatuses;
executing, in response to the request, the extended function requested by the request among the extended functions.

7. A processing apparatus, comprising:
a network interface configured to connect to a plurality of image processing apparatuses;
a receiver for receiving a request for executing an extended function from at least one of the plurality of image processing apparatuses;
a plurality of execution units configured to respectively execute extended functions in response to the request received by the receiving unit;
a memory including a data structure for storing information of extended functions available for execution, the data structure including a table which stores an identification of a function, an input device to be used by the function, a process related to the function, and an output used by the function;
a device configured to add an additional entry in the data structure for storing information so that another extended function is added to the processing apparatus; and
a control unit configured to, when the receiving unit receives the request from one of the plurality of image processing apparatuses, execute the extended function requested using one of the plurality of execution units.

8. The processing apparatus of claim 7, further comprising:
a memory including a data structure for storing information indicating extended functions which are not executable by at least one of the plurality of image processing apparatuses.
